(19) United States
(12) Patent Application Publication
(10) Pub. No.: US 2026/0298704 A1
(43) Pub. Date: Oct. 1, 2026

(54) BEAM PROFILOMETRY METHOD AND SYSTEM AT OPTICAL SURFACES USING IN-SITU OPTICAL POWER SENSORS

(71) Applicant: Trans Astronautica Corporation, Lake View Terrace, CA (US)

(72) Inventors: Joel C. Sercel, Lake View Terrace, CA (US); Richard Roberts Rieber, Altadena, CA (US); Hayden Andrew Burgoyne, Glendale, CA (US); Philip J. Wahl, Altadena, CA (US); Matthew Queen, Pasadena, CA (US); Geourg Kivijian, Tujunga, CA (US); Hunter Ray Beebe, Jurupa Valley, CA (US); James G. Small, Sonoita, AZ (US)

(21) Appl. No.: 19/478,637

(22) PCT Filed: Apr. 25, 2024
(86) PCT No.: PCT/US2024/026327

§ 371 Date: Oct. 24, 2025

Related U.S. Application Data
(60) Provisional application No. 63/499,183, filed on Apr. 28, 2023.

(51) Int. Cl. G01J 1/42; B64G 1/36; B64G 1/44; G02B 26/08

(52) U.S. Cl. CPC G01J 1/4257; B64G 1/363; B64G 1/44; G02B 26/0816; G01J 2001/4266

(57) ABSTRACT

Orbiting spacecraft use lightweight reflecting mirrors to concentrate solar energy into powerful energy beams. Smaller mirrors direct the energy to useful locations around and within the spacecraft. A system of sensors imbedded in the mirrors and a feedback control system prevent beams from damaging spacecraft structures.

### INCORPORATION BY REFERENCE TO ANY PRIORITY APPLICATIONS

This application is based upon and claims the benefit of priority from U.S. Provisional Patent Application No. 63/499,183 filed on Apr. 28, 2023. Moreover, any and all applications for which a foreign or domestic priority claim is identified in the Application Data Sheet as filed with the present application are hereby incorporated by reference under 37 CFR 1.57. The entire contents of each of the above-listed items is hereby incorporated into this document by reference and made a part of this specification for all purposes, for all that each contains.

### BACKGROUND

### Field

This application generally relates to systems and methods for precisely directing concentrated solar energy from the sun for use aboard spacecraft and for asteroid mining.

### SUMMARY

Commercial economic activity in near-earth space and in regions beyond is growing rapidly. In the inner solar system, industrial levels of continuous solar power may be collected by using light-weight concentrating mirrors. The mirrors may be deployed from orbiting spacecraft or may be installed upon relatively fixed installations such as asteroids or low gravity moons. Light-weight mirror structures can collect powerful energy beams, but their reduced dimensional stability compared to heavier terrestrial designs may allow the energy beams to wander off target causing damage to light-weight supporting structures. It is desirable to have an active control system that can compensate for dimensional changes.

One aspect of this disclosure is a feedback control systems that can implement a robust sensor method. The sensors can directly sample multiple locations across the surface of a beam-directing mirror. Inter-comparison of the sensor readings can provide an estimate of the position of the center of the energy beam as well as the beam size and shape.

Further aspects are protective shutters that can be closed to permit progressive alignment of high energy beams throughout a spacecraft beam transport system while protecting the spacecraft structure from unintended damage due to misaligned high energy beams.

Another aspect is a method of monitoring and controlling alignment of a solar energy beam within a spacecraft, the method comprising: collecting and reflecting incoming solar radiation with a first mirror to form a solar energy beam; measuring a position of the solar energy beam with a plurality of photo detectors configured to measure an intensity of the solar energy beam at different positions along a surface of an optical component; detecting displacement of a position of the solar energy beam on the optical component based on the measured position; and adjusting an orientation of the first mirror in response to detecting the displacement of the position of the solar energy beam.

In some embodiments, the displacement of the position of the solar energy beam is caused by: alignment of the first mirror toward the sun, spacecraft attitude maneuvers that involve realignment of the first mirror with the sun, spacecraft maneuvers that cause structural flexures, and/or unplanned structural deformations.

In some embodiments, the method further comprises: reflecting and focusing the solar energy beam using a plurality of optical surfaces and blocking shutters to direct the solar energy beam, wherein one or more of the optical surfaces and the blocking shutters comprises an array of imbedded pinholes and photo detectors.

In some embodiments, the method further comprises: communicating, using the photo detectors, one or more signals to a microprocessor; and measuring, using the microprocessor, a center and lateral extent of the solar energy beam relative to a size and shape of the surface of the optical component.

In some embodiments, the method further comprises: outputting, from the microprocessor, one or more control signals to one or more actuator mechanisms to adjust the orientation of the first mirror.

In some embodiments, the optical component comprises a second mirror, the method further comprising: outputting, from the microprocessor, one or more control signals to activate one or more blocking shutters to block the solar energy beam in response to detecting that the solar energy beam is within a predetermined distance of an edge of the second mirror.

In some embodiments, the spacecraft comprises a plurality of secondary mirrors and a plurality of blocking shutters, each of the secondary mirrors and each of the blocking shutters comprising a plurality of photo detectors, the method further comprising: performing, using the microprocessor, a startup and alignment including: closing each of the blocking shutters to block the solar energy beam from reaching a corresponding one of the plurality of mirrors; sending control signals to one or more actuators to center the solar energy beam on a first one of the blocking shutters based on an output received from the photo detectors of the first blocking shutter; and in sequential fashion, sending control signals to open a next one of the blocking shutters, measuring a position of the solar energy beam on a next one of the mirrors based on an output received from the photo detectors of the next one of the mirrors, and controlling a next one or more actuators to center the solar energy beam on the next mirror.

In some embodiments, the optical component comprises a blocking shutter, the method further comprising: receiving signals from the photo detectors at a microprocessor; determining, using the microprocessor, that the position of the solar energy beam on the surface of the blocking shutter is less than a threshold distance from a baseline centered position; and sending a control signal, using the microprocessor, to open the blocking shutter such that the blocking shutter does not block a path of the solar energy beam.

In some embodiments, the photo detectors are imbedded into the surface of the optical component.

Yet another aspect is a system for monitoring and controlling alignment of a solar energy beam within a spacecraft, the system comprising: a first mirror configured to collect and reflect incoming solar radiation to form a solar energy beam; a plurality of photo detectors configured to measure an intensity of the solar energy beam at different positions along a surface of an optical component; a microprocessor configured to detect displacement of a position of the solar energy beam on the surface of the optical component based on the measured intensities of the solar energy beam; and one or more actuators configured to adjust an orientation of the first mirror in response to the microprocessor detecting the displacement of the position of the solar energy beam.

In some embodiments, the displacement of the position of the solar energy beam is caused by: alignment of the first mirror toward the sun, spacecraft attitude maneuvers that involve realignment of the first mirror with the sun, spacecraft maneuvers that cause structural flexures, and/or unplanned structural deformations.

In some embodiments, the system further comprises: a plurality of reflecting and focusing optical surfaces; and a plurality of blocking shutters, the optical surfaces and the blocking shutters are configured to direct the solar energy beam, wherein each of the optical surfaces and the blocking shutters comprises an array of imbedded pinholes and additional photo detectors.

In some embodiments, the optical component comprises a reflecting surface having a plurality of first holes formed therein, the first holes spaces across the reflecting surface of the optical component, and a plurality of second holes penetrate from a second surface of the optical component on an opposite side of the optical component from the reflecting surface, each of the second holes being larger than and intercepting a corresponding one of the first holes.

In some embodiments, each of the photo detectors is installed at an end of or within a corresponding one of the second holes, the photo detectors are configured receive a portion of light that is transmitted through the first holes, and the system further comprises a microprocessor coupled to the photo detectors.

In some embodiments, each of the first holes defines an interior surface that is polished or coated to enhance reflection of light and thereby increase transmission of light through the first holes.

In some embodiments, the system further comprises: an optical guiding element installed in each of the first holes, wherein a first end of each of the optical guiding elements is substantially flush with or below the reflecting surface of the optical component, and a second end of each of the optical guiding elements is bonded to an optical input surface of a corresponding one of the photo detectors.

In some embodiments, the system further comprises: an electronic circuit board comprising the photo detectors and other electronic signal processing components coupled to the optical guiding elements, wherein the electronic circuit board is configured to communicate electrically with a microprocessor.

In some embodiments, the system further comprises: a plurality of optical guiding elements respectively installed through the first holes and the second holes, wherein an input end of each of the optical guiding elements is substantially flush with or below the reflecting surface of the optical component, wherein, after passing through the first and second holes, the optical guiding elements are gathered together into a flexible bundle forming a multi element optical cable, wherein at a remote end of the optical cable, output ends of the individual guiding elements are separately bonded to the photo detectors, and wherein the photo detectors are arranged on an electronic circuit board that is located adjacent to a microprocessor.

In some embodiments, the photo detectors are imbedded into the surface of the optical component.

In some embodiments, the optical component comprises a blocking shutter, the system further comprising: a microprocessor configured to receive signals from the photo detectors, determine that the position of the solar energy beam on the surface of the blocking shutter is less than a threshold distance from a baseline centered position, and send a control signal to open the blocking shutter such that the blocking shutter does not block a path of the solar energy beam.

These and other features and advantages of the present disclosure will be apparent to those skilled in the art from the following detailed description, taken together with the accompanying drawings, in which like reference numerals refer to like parts.

### BRIEF DESCRIPTION OF THE DRAWINGS

FIG. 1 is a schematic illustration of a spacecraft installed within a launch vehicle where the various light-weight structures of the spacecraft are folded into compact configurations.

FIG. 2 is a schematic illustration of an orbiting spacecraft where light-weight structures have been unfolded and deployed to operational configurations.

FIG. 3 is a schematic illustration of the collection and concentration of solar energy by light-weight reflecting structures including protective shutters.

FIG. 4 illustrates an array of pinholes and sensors embedded across the face of highly reflecting mirrors.

FIGS. 5A and 5B illustrates details of pinholes and sensors embedded in a reflecting mirror.

FIG. 6 illustrates the passage of light rays through a pinhole and to a detector.

FIG. 7 illustrates an optical fiber designed to guide light through a pinhole to a detector.

FIG. 8 illustrates a plurality of optical fibers that guide light from pinholes to remote detectors.

FIG. 9 illustrates one operational embodiment of a control algorithm configured keep the energy beam aligned during continuing spacecraft operations.

### DETAILED DESCRIPTION

When launching spacecraft by rockets from the surface of the Earth, the spacecraft are typically carried within the aerodynamic nose cone of the launch vehicle. It is desirable to reduce launch costs by minimizing both the total mass of the spacecraft and its physical size. It is therefore useful to employ compact and light-weight structures wherever possible.

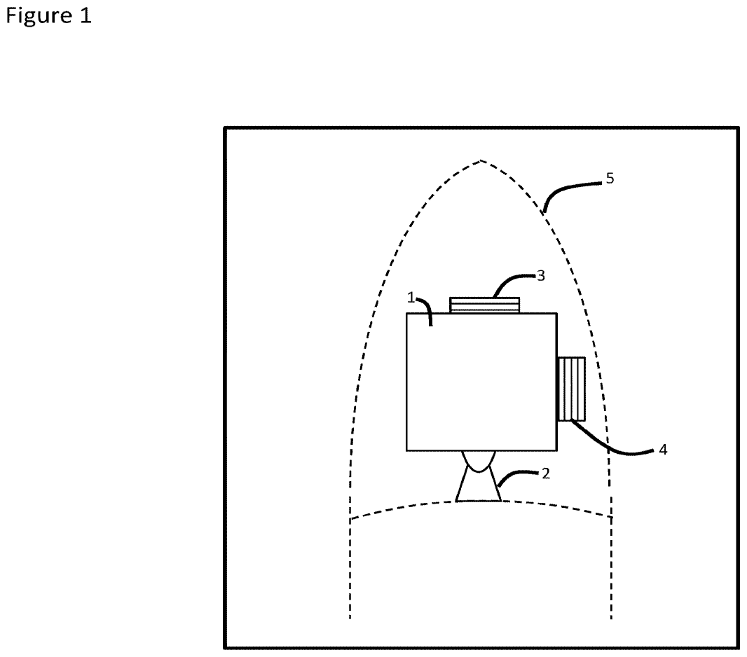

FIG. 1 illustrates an embodiment of an asteroid mining spacecraft 1 situated atop a launch rocket. The main body of the spacecraft 1, also called the bus, contains the fuel, electrical components and communication equipment for a typical mission. Although the spacecraft 1 is described as being configured to asteroid mining as an example, aspects of this disclosure are not limited thereto and the described techniques for monitoring alignment of a solar energy beam can be employed in various different types of spacecrafts 1 without departing from aspects of this disclosure.

The asteroid mining spacecraft 1 is further provided with one or more rocket propulsion systems 2 to provide maneuvering capability to allow the spacecraft 1 to reach and capture passing asteroids. The spacecraft 1 also contains an asteroid capture system 3 and a solar power collection system 4, both of which are shown in a folded and stowed configuration. The booster rocket 5 is shown schematically by dashed lines.

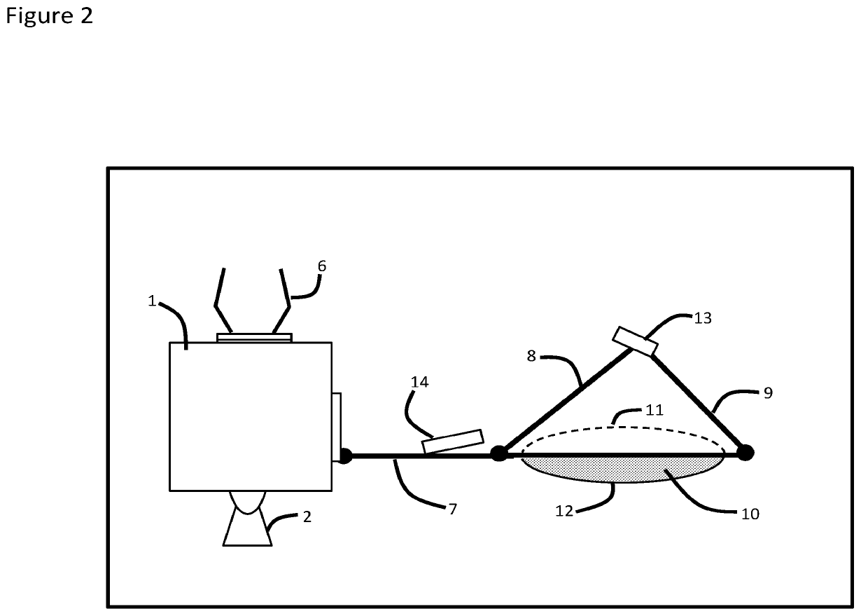

FIG. 2 depicts the asteroid mining spacecraft 1 in orbital flight after it has separated from the booster rocket 5. The asteroid capture system 6 is shown in a deployed configuration. Depending on the embodiment, the asteroid capture system 6 can include multiply-jointed rigid members and/or of hollow tubular polymer membranes which have been inflated by internal gas pressure. Other implementations are also possible.

FIG. 2 further depicts the solar power collection system 4 after it has been unfolded and deployed from its compact stowed configuration. The solar power collection system 4 includes a plurality of linear support elements 7, 8, and 9 which, in one embodiment, may be tubular polymer membranes that have been inflated and held rigid by internal pressurizing gas.

Inflation can be controlled through a series of valves and gas supply tubes (not illustrated) that connect between each inflated stage and a bottle of compressed gas (not illustrated). The gas bottle can be filled prior to spacecraft launch in some implementations. For clarity in FIG. 2, these details are not depicted.

A hollow lens-shaped or inflated lenticular structure 10 provides a transparent upper surface 11, shown as a broken line, and a curved reflecting lower surface 12. The surface 12 serves as a curved mirror to collect and focus incoming solar radiation. Additional rigid reflecting elements 13 and 14 along with additional optical components not shown may be used to direct a focused energy beam.

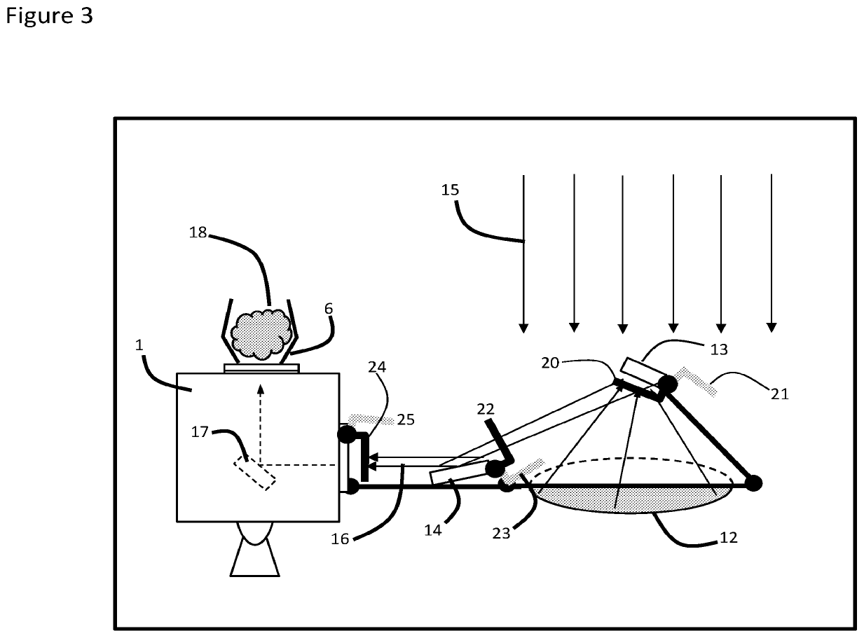

FIG. 3 illustrates certain components involved in collecting solar energy and focusing the solar energy into a powerful energy beam when all shutters are in their non-blocking positions. When the collecting curved mirror 12 is pointed at the Sun, a portion of the incoming solar radiation 15 reflects from the curved surface 12 and converges toward secondary mirror 13.

With a substantially unobstructed view of the Sun, this method can be used to collect very intense power beams using the solar power collection system 4. For example, in an embodiment in which the mirror 12 has a collecting area of 1 square meter, the continuous power collected will exceed one kilowatt of thermal energy for spacecraft located at the Earth's orbital distance from the Sun. When focused to a spot of several centimeters in diameter, this is sufficient power density to drill a hole into concrete or into a captured asteroid 18. Larger collecting mirrors and multiple mirror configurations can collect proportionally larger power beams.

The additional rigid reflecting elements 13 and 14 can be configured to adjust the focus and direction of the concentrated energy beam 16. The energy beam 16 can be directed into the spacecraft 1 via the rigid reflecting elements 13 and 14 where one or more additional optical components 17 can direct the beam to pass through the asteroid capture system 6 and to impinge upon a captured asteroid 18. The concentrated solar energy can be used to drill holes into the asteroid, to melt and vaporize volatile constituents of the asteroid material, and/or to cause spalling and excavation of the asteroid 18 surface. In other embodiments, the concentrated solar energy can also be used for other useful work including, for example, providing energy to the one or more rocket propulsion systems 2. This energy can be converted into thrust, for example, by heating fuel in the one or more rocket propulsion systems 2.

It can be seen from the above description that it is desirable to carefully focus a powerful energy beam 16 and direct the focused energy beam 16 to avoid hitting and damaging parts of the spacecraft 1 structure. There are several conditions that may affect a dynamic misalignment of the beam 16. These include errors in pointing reflecting mirror 12 directly at the sun, mechanical deformations of light-weight structures 6 through 12 due to spacecraft maneuvering forces, and slowly changing dimensions of structures 6 through 12 due to material fatigue or due to pressurization loss caused by micro meteor impacts. Those skilled in the art will recognize that other conditions may also cause a dynamic misalignment of the beam 16.

Therefore, it is desirable to incorporate system and techniques for continually monitoring the position and focus of energy beam 16. It is also desirable to incorporate shutters which can safely block or prevent the formation of an energy beam 16 during solar alignment maneuvers. It is further desirable to quickly block the energy beam 16 should there be unexpected upsets in any of the spacecraft control systems, a so called “dead man” automatic safety shutdown system.

FIG. 3 further depicts safety blocking shutters 20, 22, and 24 which can rotate and/or slide into position according to commands from a microprocessor (not shown). The shutters 20, 22, and 24 are shown in the blocking position in FIG. 3. The same shutters 20, 22, and 24 are shown lightly shaded in their non-blocking positions at 21, 23, and 25.

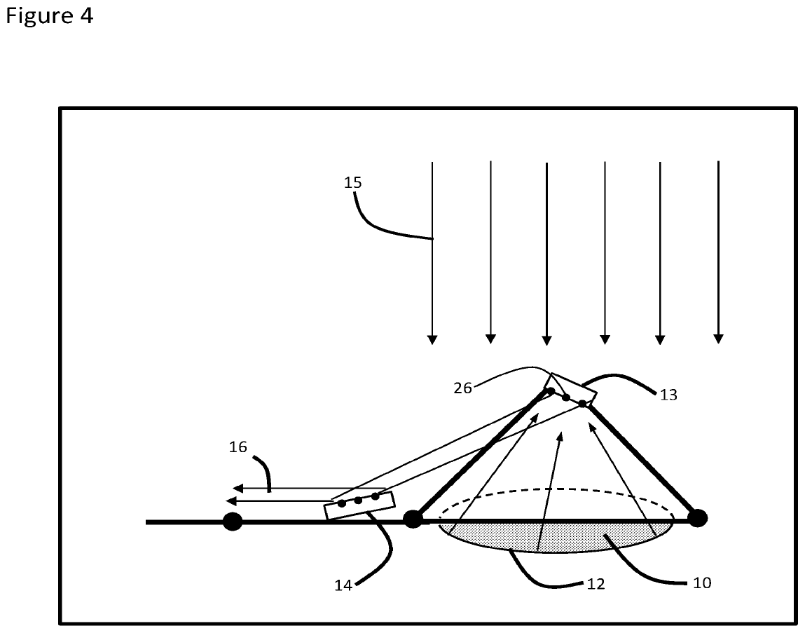

Referring to FIG. 4, reflected light from the curved mirror 12 is shown converging onto the rigid reflecting mirror 13. For clarity, the safety shutters are not shown. In some implementations, the reflecting surface of the mirror 13 may be curved to provide additional focusing of the converging energy beam 16.

In this embodiment, the reflecting surface of the mirror 13 contains an array of small pinholes and light-sensitive photo-detecting elements 26. The reflecting surface of the mirror 14 contains a similar array. In like manner, additional reflecting elements used to further control the concentrated energy beam 16 may be provided with additional arrays of pinholes and photo detectors, depending on the embodiment. Although not shown, it is understood that blocking shutters may also be equipped with similar arrays of pinholes and light-sensitive photodetectors.

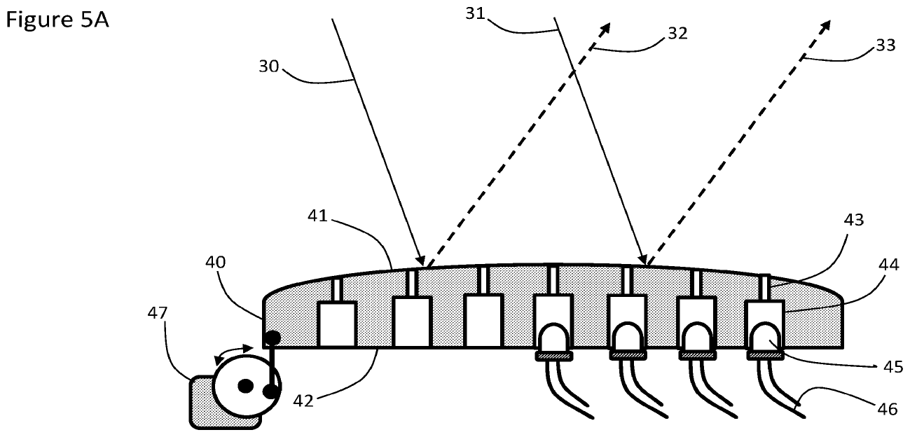

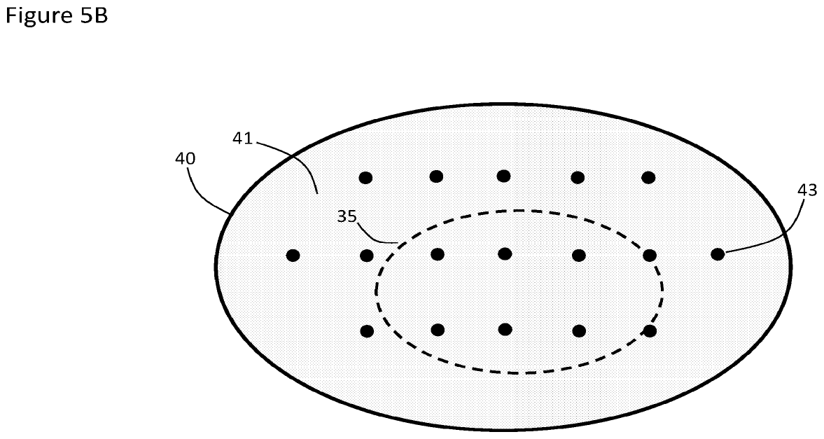

FIG. 5A depicts a cross section through a reflecting mirror 40. In this depiction, the reflecting surface 41 of the mirror 40 need not be flat and is shown as curved, convex upward. However, in other embodiments, the reflecting surface 41 may be substantially flat or concave. An incident solar energy beam, depicted by boundary rays 30 and 31, reflects from the reflecting surface 41. The diameter of the incoming solar energy beam as it impinges upon the mirror 40 is approximately indicated by the distance of separation between the boundary rays 30 and 31. The reflected beam is depicted by broken line boundary rays 32 and 33. The mirror 40 is designed to be substantially wider than the diameter of the solar energy beam. When the mirror 40 is wider than the energy beam, small misalignments of the energy beam will not cause substantial solar power to wander off the mirror 40 and potentially impinge upon and damage other spacecraft 1 structures.

FIG. 5A further depicts an array of small pinholes 43 that have been formed in the reflecting surface part way into the interior of the mirror 40 structure. In some implementations, the small pinholes 43 may be formed by drilling through the reflecting surface 41 of the mirror 40. Larger holes 44 are formed in the reverse, nonreflecting side 42 of the mirror 40 and intercept the pinholes 43. In some embodiments, the larger holes 44 may be counter-drilled from the reverse non-reflecting side 42. Photo detectors 45 are installed in the larger holes 44. The photo detectors 45 can include, for example: photo diodes, photo transistors, photo resistors such as CdS; or thermal detectors sensitive to heating due to light energy such as bolometers, thermocouples, thermistors or thermometers. Each of the photo detectors 45 can be configured to measure the intensity (or brightness) of light entering a corresponding one of the pinholes 43 in the surface 41 of the mirror 40.

Electrical connections 46 conduct the detected signals to a remote microprocessor not shown in the Figure. Also depicted is an electric motor and linkage arm 47 that can be actuated by microprocessor commands to move the mirror 40 to various degrees of tilt.

FIG. 5B depicts a plan view of the reflecting surface 41 of the mirror 40. In this example, the mirror 40 is elliptical in shape. Other mirror shapes from round to elongated rectangles may be used. Also depicted as broken ellipse 35 is the spot size and location of the solar energy beam. The energy of the beam is substantially contained within the area indicated by the broken ellipse 35. Multiple pinholes 43 are arrayed across the mirror surface.

FIG. 5B depicts an incoming solar energy beam, defined by the broken ellipse 35, that is not perfectly centered on the reflecting surface 41 of the mirror 40. Because the photo detectors 45 are configured to measure the intensity of the light that enters the corresponding pinholes 43 in the surface 41 of the mirror, the center position and lateral extent of the solar energy beam can be estimated by the remote microprocessor through comparing the relative strength of electrical signals from the various photo detectors 45. For example, the detectors 45 nearer the center of the beam spot 35 will register higher detected light levels than other detectors 45 farther away from the center of the beam spot 35.

Unplanned deformations in the spacecraft 1 structure may cause a beam 16 to wander from its ideal centered position. If the incoming beam 16 wanders beyond predetermined engineering limits, the microprocessor can, in response to detecting the movement of the beam 16 outside of tolerance, actuate electric motors similar to 47 (referred to generally as actuator(s)) or other mechanisms, such as piezoelectric or electro-optical devices, that cause optical components upstream of the mirror 40 to direct the incoming beam 16 back into tolerance. In some implementations, the microprocessor may be configured to determine that the beam 16 has moved outside of tolerance in response to the center of the beam 16 being a more than threshold distance from a baseline centered position (e.g., an ideal or predefined centered position). For example, the microprocessor may be configured to detect displacement of the position of the beam 16 from a baseline centered position, and adjust the orientation of the mirror 40 in response to detecting the displacement of the position of the beam 16. In some implementations, the microprocessor may be configured to determine that the beam 16 has moved outside of tolerance in response to detecting that the solar energy beam 16 is within a predetermined distance of an edge of the mirror 40.

In a similar fashion, the actuator 47 may be controlled by the microprocessor to direct the outgoing beam 16, defined by boundary rays 32 and 33, to be substantially centered on the next optical component in the beam 16 train. If the beam 16 wanders beyond the control capability of the actuators 47, then the microprocessor can actuate one or more of the shutters 20, 22, and 24 to block the beam 16 before the beam 16 can cause excessive heating and unintended damage to the spacecraft 1 structure.

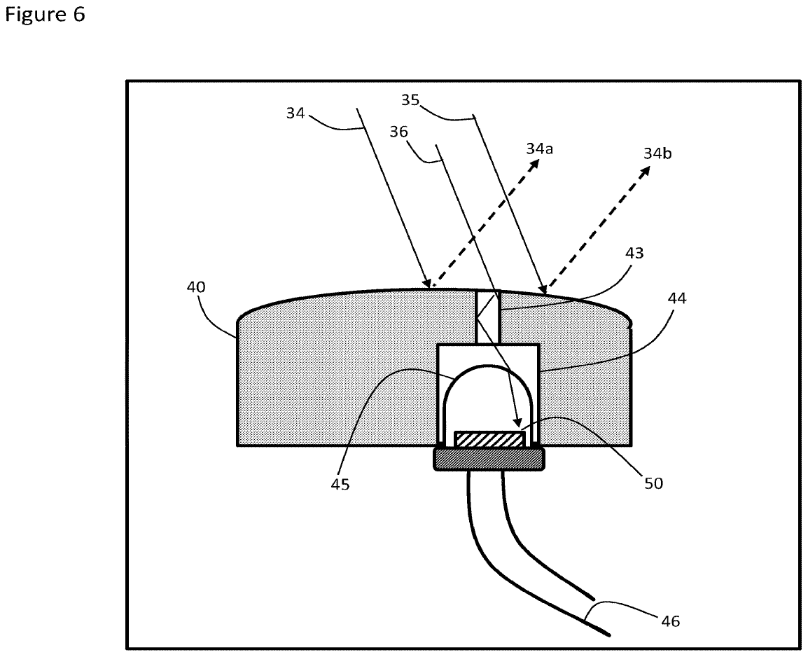

FIG. 6 illustrates an expanded view of a single pinhole 43 and detector 45. Incoming light rays indicated by arrows 34, 35, and 36 arrive at an oblique angle with respect to the axis of the pinhole 43. In the case shown, ray 36 reflects from the walls of the pinhole multiple times before the ray 36 enters the light detector 40. Ray 36 eventually terminates at the photo-sensitive element 50, where the ray 36 contributes to an output signal over electrical connections 46. In some embodiments, the inner surface of the pinholes 43 are polished and/or coated to increase the reflectivity of the inner surface of the pinholes 43. Advantageously, this polished and/or coated inner surface can reduce or minimize the loss of light to provide a more accurate measurement of the amount of light entering the corresponding pinhole 43. Furthermore, similarly polished and/or coated pinholes 43 across the mirror surface 41 will produce similar signals in the multiple photo detectors 45. Unpolished or rough surfaced pinholes 43 could contribute to undesirable variations in the sensitivity and calibrations of the multiple photo detectors 45. Thus, by providing a more uniform level of polishing and/or coating on the inner surfaces of the pinholes 43, the measurement of the amount of light entering the different pinholes 43 can be more accurately compared to each other.

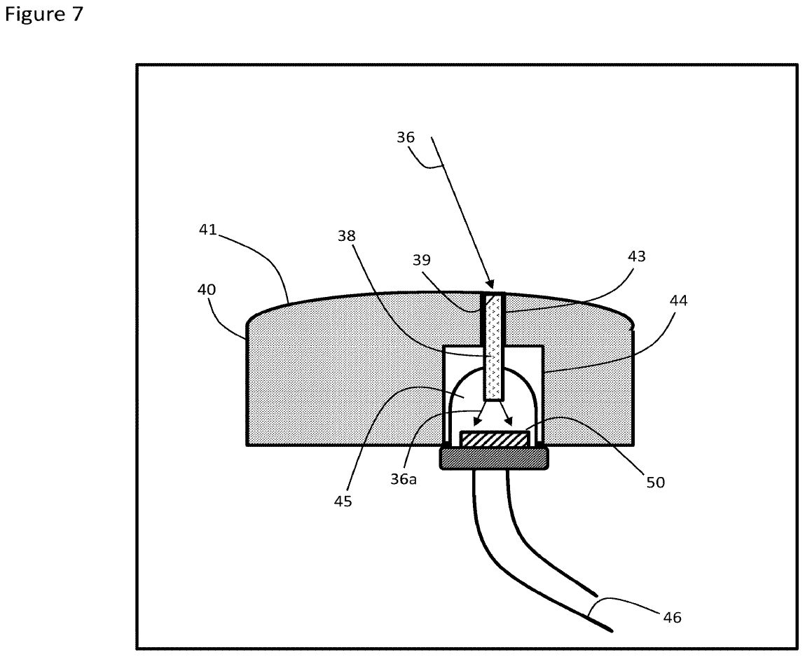

FIG. 7 illustrates an embodiment where a light guide or optical fiber 38 has been inserted into the pinhole 43. The top surface 39 of the light guide is positioned substantially flush with the mirror reflecting surface 41. The bottom end of the light guide 38 is inserted into a hole that has been formed (e.g., drilled) in the input lens of the photo detector 45. Light ray 36 enters the top surface of guide 38 and exits the bottom surface above the detector photo-sensitive element 50 without reflecting from the surface of the pinhole 43. In this embodiment, the light ray 36 can be guided to the detector photo-sensitive element 50 via the light guide or optical fiber 38 with reduced or minimal losses without polishing or coating the interior surface of the pinhole 43.

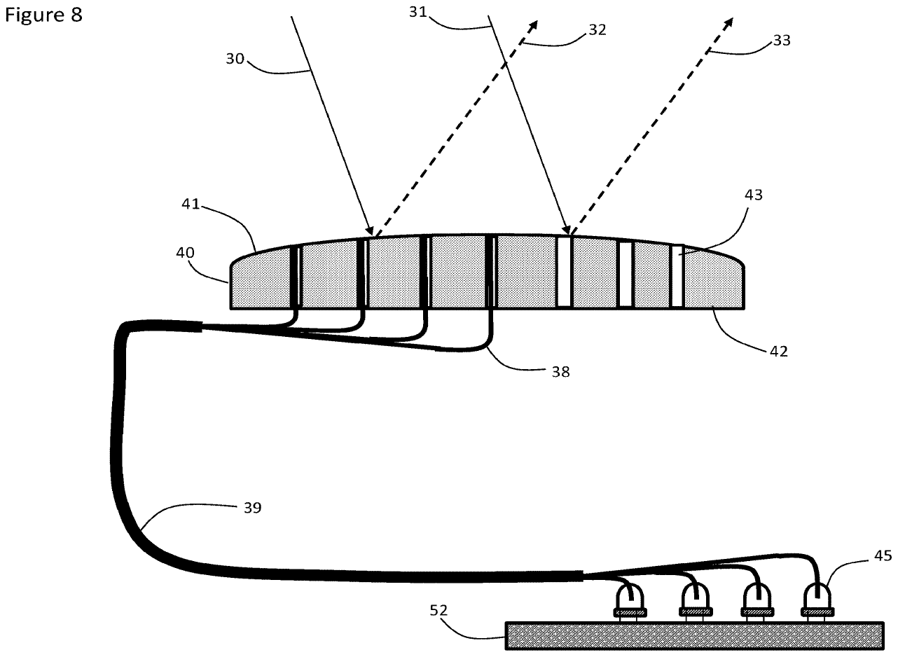

FIG. 8 illustrates an embodiment where photo detectors 45 may be positioned away from the reflecting mirror 40 and conveniently close to a microprocessor. In this embodiment, relatively small pinholes 43 may be formed (e.g., drilled) completely through the mirror 40 structure from front surface 41 to back 42. In this embodiment, there is no need to counter drill the pinholes 43 with a larger hole. However, this configuration can also be implemented with counter-drilled holes.

A short or a relatively long flexible optical light guide 38 is bonded into each pin hole 43. Longer flexible guides 38 may be gathered together into a compact flexible cable bundle 39 which may be up to several meters in length. At the output end of the bundle 39, the light guides 38 are separated and bonded to individual photo detectors 45. The photo detectors 45 may be compactly installed on an electronic circuit board 52. Very short electrical connections between the photo detectors 45 and the circuit board 52 are desirable to reduce possibilities for electrical interference. The flexible bundle 39 permits the mirror 40 to be mechanically moved in tip and tilt directions to adjust the orientation of the mirror 40 while still remaining connected to the remote detectors 45 and microprocessor.

In the present embodiment and referring again to FIG. 3, the blocking shutters 20, 22, and 24 may be used as safety devices that are instructed to close in order to prevent unintended damage due to uncontrolled deformations of the spacecraft 1 structure. The blocking shutters 20, 22, and 24 may also be used during initial alignment of the powerful solar energy beam 16. When first aligning the large collecting mirror 12 toward the direction of the sun, some or all of the blocking shutters 20, 22, and 24 can be configured in their blocked positions.

The first blocking shutter 20 to encounter the converging solar energy beam, like many other optical component, can be equipped with an array of pinholes 43 and detectors 45. The position of the energy beam 16 on the blocking shutter 20 can be determined by microprocessor calculations from the detector signals. Alignment of the first mirror 12 based on the detector signals received from the optical components in the first block shutter 20 can proceed before the energy beam 16 is allowed to impinge on the second mirror 13.

When the beam 16 alignment is adjusted to be within engineering limits (e.g., the center of the beam is within a threshold distance of a baseline centered position) on the blocking shutter 20, the shutter 20 can be opened. The beam 16 will be sufficiently accurate in direction to ensure that the beam 16 impinges on the second mirror 13. The pinholes 43 and detectors 45 on the mirror 13 can then be used for further fine-adjust the alignment of mirror 12 if needed.

With the shutter 20 open, the reflected beam 16 from the second mirror 13 will be intercepted by the second blocking shutter 22. In a similar manner, the second mirror 13 can be adjusted in orientation (e.g., in tip and tilt) to ensure that the energy beam 16 is centered on the second blocking shutter 22 within a threshold of a baseline centered position. When the beam 16 is sufficiently centered on the second blocking shutter 22, the shutter 22 can be opened with confidence that the energy beam 16 will safely impinge on the third mirror 14. By sequentially opening blocking shutters 20, 22, and 24 in this manner, the energy beam 16 can be guided throughout the spacecraft 1 without unintentional damage to lightweight spacecraft 1 structures at any stage during the alignment process.

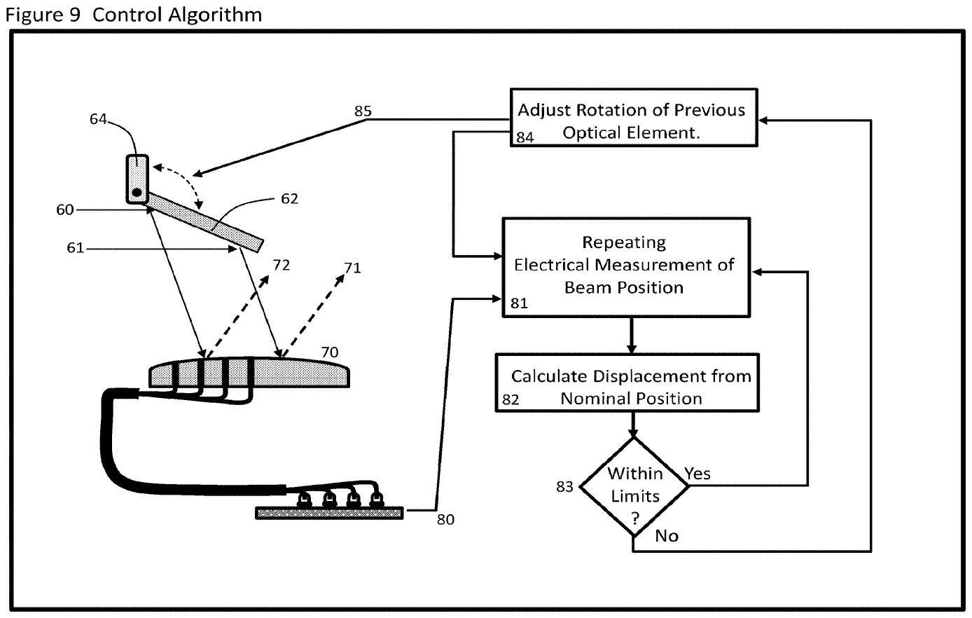

FIG. 9 illustrates one operational embodiment of a control algorithm configured keep the energy beam aligned during continuing spacecraft 1 operations. In the physical hardware, an incoming energy beam illustrated by boundary rays 60 and 61, reflects from a mirror 62. The orientation of the mirror 62 can be adjusted (e.g., adjusted in tip or tilt directions) by actuator 64. The reflected beam then impinges on mirror 70 and is further reflected as indicated by boundary rays 71 and 72. The mirror 70 is shown equipped with an array of pinholes and detectors.

The control algorithm is indicated by the logic flow diagram in the right half of the FIG. 9. The algorithm is physically implemented in a microprocessor. Multiple parallel electrical signals 80 from the detector array are repeatedly measured by the microprocessor in logic box 81 to determine the alignment of the energy beam on the mirror 70 as described previously. For example, the measurement cycle may be repeated 10 times per second. In logic box 82, the microprocessor calculates the displacement of each energy beam measurement from the desired alignment (e.g., from a baseline centered position). In step 83, the microprocessor determines whether the most recently measured beam alignment is within acceptable engineering limits (e.g., within a threshold distance from the baseline centered position). In response to determining that the most recently measured beam alignment is within acceptable engineering limits, then the logical steps above repeat with a new position measurement (e.g., the control algorithm returns to logic box 81). In response to determining that the most recently measured beam alignment is not within acceptable engineering limits, then logic box 84 calculates the change needed in orientation (e.g., tip or tilt) of the mirror 62 to bring the beam position back within engineering limits. Logic box 84 then sends an electrical signal 85 to adjust the actuator 64 to a new orientation (e.g., tip and/or tilt) of the mirror 62 position. Box 84 further sends a logical command to box 81 to resume taking position measurements and the algorithmic cycle repeats.

This algorithm may be applied to any sequential pair of mirrors in the solar energy beam train wherein the first mirror is equipped with an adjustable orientation (e.g., tip or tilt) actuator and the second mirror is equipped with an array of pinholes and detectors. In general, this algorithm will be applied continually and sequentially to all appropriately equipped mirror pairs in the spacecraft 1. A similar algorithm can also be applied during the initial alignment process based on electrical signals 80 from a detector array positioned in the blocking shutters 20, 22, and 24 instead of or in addition to signals received from electrical signals 80 from the detector array positioned in the mirror 70.

FIGS. 1 through 9 are conceptual illustrations allowing for an explanation of the present invention. The figures and examples above are not meant to limit the scope of the present invention to a single embodiment or to the use of specific physical components. Furthermore, the scale and dimensions of the elements illustrated in each of the figures may be exaggerated for ease of illustration and embodiments of this disclosure are not limited thereto.

It is to be understood that not necessarily all objects or advantages may be achieved in accordance with any particular embodiment described herein. Certain embodiments may be configured to operate in a manner that achieves or optimizes one advantage or group of advantages as taught herein without necessarily achieving other objects or advantages as may be taught or suggested herein.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “might,” “may,” “e.g.,”“for example,” and the like, unless specifically stated otherwise, or otherwise understood within the context as used, is generally intended to convey that certain embodiments include, while other embodiments do not include, certain features, elements, or states. Thus, such conditional language is not generally intended to imply that features, elements or states are in any way required for one or more embodiments.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Such disjunctive language is not generally intended to, and should not, imply that certain embodiments require at least one of X, at least one of Y, and at least one of Z to each be present. Thus, the term “or” is used in its inclusive sense (and not in its exclusive sense) so that when used, for example, to connect a list of elements, the term “or” means one, some, or all of the elements in the list.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The terms “comprising,” “including,” “having,” and the like are synonymous and are used inclusively, in an open-ended fashion, and do not exclude additional elements, features, acts, operations, and so forth.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others.

What is claimed is:

1. A method of monitoring and controlling alignment of a solar energy beam within a spacecraft, the method comprising:
collecting and reflecting incoming solar radiation with a first mirror to form a solar energy beam;
measuring a position of the solar energy beam with a plurality of photo detectors configured to measure an intensity of the solar energy beam at different positions along a surface of an optical component;
detecting displacement of a position of the solar energy beam on the optical component based on the measured position; and
adjusting an orientation of the first mirror in response to detecting the displacement of the position of the solar energy beam.

2. The method of claim 1, wherein the displacement of the position of the solar energy beam is caused by: alignment of the first mirror toward the sun, spacecraft attitude maneuvers that involve realignment of the first mirror with the sun, spacecraft maneuvers that cause structural flexures, and/or unplanned structural deformations.

3. The method of claim 1, further comprising:
reflecting and focusing the solar energy beam using a plurality of optical surfaces and blocking shutters to direct the solar energy beam,
wherein one or more of the optical surfaces and the blocking shutters comprises an array of imbedded pinholes and photo detectors.

4. The method of claim 1, further comprising:
communicating, using the photo detectors, one or more signals to a microprocessor; and
measuring, using the microprocessor, a center and lateral extent of the solar energy beam relative to a size and shape of the surface of the optical component.

5. The method of claim 4, further comprising:
outputting, from the microprocessor, one or more control signals to one or more actuator mechanisms to adjust the orientation of the first mirror.

6. The method of claim 4, wherein the optical component comprises a second mirror, the method further comprising:
outputting, from the microprocessor, one or more control signals to activate one or more blocking shutters to block the solar energy beam in response to detecting that the solar energy beam is within a predetermined distance of an edge of the second mirror.

7. The method of claim 4, wherein the spacecraft comprises a plurality of secondary mirrors and a plurality of blocking shutters, each of the secondary mirrors and each of the blocking shutters comprising a plurality of photo detectors, the method further comprising:
performing, using the microprocessor, a startup and alignment including:
closing each of the blocking shutters to block the solar energy beam from reaching a corresponding one of the plurality of mirrors;
sending control signals to one or more actuators to center the solar energy beam on a first one of the blocking shutters based on an output received from the photo detectors of the first blocking shutter; and
in sequential fashion, sending control signals to open a next one of the blocking shutters, measuring a position of the solar energy beam on a next one of the mirrors based on an output received from the photo detectors of the next one of the mirrors, and controlling a next one or more actuators to center the solar energy beam on the next mirror.

8. The method of claim 1, wherein the optical component comprises a blocking shutter, the method further comprising:
receiving signals from the photo detectors at a microprocessor;
determining, using the microprocessor, that the position of the solar energy beam on the surface of the blocking shutter is less than a threshold distance from a baseline centered position; and
sending a control signal, using the microprocessor, to open the blocking shutter such that the blocking shutter does not block a path of the solar energy beam.

9. The method of claim 1, wherein the photo detectors are imbedded into the surface of the optical component.

10. A system for monitoring and controlling alignment of a solar energy beam within a spacecraft, the system comprising:
a first mirror configured to collect and reflect incoming solar radiation to form a solar energy beam;
a plurality of photo detectors configured to measure an intensity of the solar energy beam at different positions along a surface of an optical component;
a microprocessor configured to detect displacement of a position of the solar energy beam on the surface of the optical component based on the measured intensities of the solar energy beam; and
one or more actuators configured to adjust an orientation of the first mirror in response to the microprocessor detecting the displacement of the position of the solar energy beam.

11. The system of claim 10, wherein the displacement of the position of the solar energy beam is caused by: alignment of the first mirror toward the sun, spacecraft attitude maneuvers that involve realignment of the first mirror with the sun, spacecraft maneuvers that cause structural flexures, and/or unplanned structural deformations.

12. The system of claim 10, further comprising:
a plurality of reflecting and focusing optical surfaces; and
a plurality of blocking shutters, the optical surfaces and the blocking shutters are configured to direct the solar energy beam,
wherein each of the optical surfaces and the blocking shutters comprises an array of imbedded pinholes and additional photo detectors.

13. The system of claim 10, wherein:
the optical component comprises a reflecting surface having a plurality of first holes formed therein, the first holes spaces across the reflecting surface of the optical component, and
a plurality of second holes penetrate from a second surface of the optical component on an opposite side of the optical component from the reflecting surface, each of the second holes being larger than and intercepting a corresponding one of the first holes.

14. The system of claim 13, wherein:
each of the photo detectors is installed at an end of or within a corresponding one of the second holes,
the photo detectors are configured receive a portion of light that is transmitted through the first holes, and
the system further comprises a microprocessor coupled to the photo detectors.

15. The system of claim 13, wherein each of the first holes defines an interior surface that is polished or coated to enhance reflection of light and thereby increase transmission of light through the first holes.

16. The system of claim 13, further comprising:
an optical guiding element installed in each of the first holes,
wherein a first end of each of the optical guiding elements is substantially flush with or below the reflecting surface of the optical component, and
a second end of each of the optical guiding elements is bonded to an optical input surface of a corresponding one of the photo detectors.

17. The system of claim 16, further comprising:
an electronic circuit board comprising the photo detectors and other electronic signal processing components coupled to the optical guiding elements,
wherein the electronic circuit board is configured to communicate electrically with a microprocessor.

18. The system of claim 13, further comprising:
a plurality of optical guiding elements respectively installed through the first holes and the second holes,
wherein an input end of each of the optical guiding elements is substantially flush with or below the reflecting surface of the optical component,
wherein, after passing through the first and second holes, the optical guiding elements are gathered together into a flexible bundle forming a multi element optical cable,
wherein at a remote end of the optical cable, output ends of the individual guiding elements are separately bonded to the photo detectors, and
wherein the photo detectors are arranged on an electronic circuit board that is located adjacent to a microprocessor.

19. The system of claim 11, wherein the photo detectors are imbedded into the surface of the optical component.

20. The system of claim 11, wherein the optical component comprises a blocking shutter, the system further comprising:
a microprocessor configured to receive signals from the photo detectors, determine that the position of the solar energy beam on the surface of the blocking shutter is less than a threshold distance from a baseline centered position, and send a control signal to open the blocking shutter such that the blocking shutter does not block a path of the solar energy beam.
